(19) United States
(12) Patent Application Publication
(10) Pub. No.: US 2026/0006503 A1
(43) Pub. Date: Jan. 1, 2026

(54) METHODS, DEVICES, AND MEDIUM FOR COMMUNICATION

(71) Applicant: NEC Corporation, Tokyo (JP)

(72) Inventors: Gang WANG, Beijing (CN); Lin LIANG, Beijing (CN)

(73) Assignee: NEC Corporation, Tokyo (JP)

(21) Appl. No.: 19/111,951

(22) PCT Filed: Sep. 27, 2022
(86) PCT No.: PCT/CN2022/121878

§ 371 Date: Mar. 14, 2025

(51) Int. Cl. H04W 36/00; H04L 69/22; H04L 69/322

(52) U.S. Cl. CPC H04W 36/0072; H04L 69/22; H04L 69/322

(57) ABSTRACT

Example embodiments of the present disclosure relate to methods, devices, and computer storage medium for communication. The method comprises: receiving, at a terminal device from a network device, at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set, and processing the PDU set based on the received at least one of the parameters. In this way, packet processing with PDU set granularity is supported, and PDU-set based handling is also supported. Therefore, communication quality and network performance are improved.

### FIELD

Example embodiments of the present disclosure generally relate to the field of communication techniques and in particular, to methods, devices, and a computer readable medium for communication.

### BACKGROUND

In 3GPP (The Third Generation Partnership Project) Release 18 (also referred to as “Rel-18”), extended Reality (XR) has gained more and more attention. XR-awareness by a terminal device (also referred to as “UE” or “user equipment”) and a network device (also referred to as “gNB”) would improve the user experience, improve the new radio (NR) system capacity in supporting XR services, and reduce the power consumption of the terminal device.

Due to Internet Protocol (IP) segmentation or other reasons, a video frame in XR traffic may arrive at Radio Access Network (RAN) as a set of protocol data units (PDUs, e.g. multiple IP packets). For XR/media services, a group of packets is used to carry payloads of a PDU set (which means “a set of PDUs”, e.g. a frame, video slice/tile). Packets in such a PDU set are decoded and/or handled as a whole. PDU-set based quality of service (QOS) handling is under study and it would impact the design of RAN protocols.

However, in current 5G system (5GS), a single PDU in the QoS flow is the finest granularity of QoS differentiation in the PDU session. The processing of each data packet in the QoS flow is relatively independent. Therefore, packet processing with PDU set granularity is not supported. For RAN and UE, PDU-set based handling is not supported too. How to reflect PDU set information in Uu interface (air interface) should also be studied.

### SUMMARY

In general, example embodiments of the present disclosure provide methods, devices and a computer storage medium for communication, especially for reporting similarity information between training/predicted/preconfigured beam information and field/actual beam information.

In a first aspect, there is provided a method of communication. The method comprises: receiving, at a terminal device from a network device, at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set, and processing the PDU set based on the received at least one of the parameters.

In a second aspect, there is provided a method of communication. The method comprises: determining, at a network device, at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set, and transmitting, to a terminal device, the at least one of the parameters.

In some example embodiments, the network device is a source network device for the terminal device to be handed over to a target network device, and the method of the second aspect further comprises: transmitting, to the target network device, a message for handover request passing information to prepare the handover to the target network device, the information comprising at least PDU set related information, the PDU set related information comprising information about at least the first parameter and the second parameter.

In some example embodiments, the network device is a target network device for a terminal device to be handed over from a source network device, and the method further comprises: receiving, from the source network device, a message for handover request passing information to prepare the handover at the target network device, the information comprising at least PDU set related information, the PDU set related information comprising information about at least the first parameter and the second parameter.

In a third aspect, there is provided a terminal device. The terminal device comprises a processor and a memory storing computer program codes. The memory and the computer program codes are configured to, with the processor, cause the terminal device to perform the method of the first aspect.

In a fourth aspect, there is provided a network device. The network device comprises a processor and a memory storing computer program codes. The memory and the computer program codes are configured to, with the processor, cause the network device to perform the method of the second aspect.

In a fifth aspect, there is provided a computer readable medium having instructions stored thereon. The instructions, when executed by a processor of an apparatus, cause the apparatus to perform the method of the first or second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication system in which some embodiments of the present disclosure can be implemented;

FIG. 2 illustrates an example signaling chart in accordance with some example embodiments of the present disclosure;

FIG. 3A illustrates an first example PDCP data PDU format in accordance with some example embodiments of the present disclosure;

FIG. 3B illustrates a second example PDCP data PDU format in accordance with some example embodiments of the present disclosure;

FIG. 3C illustrates a third example PDCP data PDU format in accordance with some example embodiments of the present disclosure;

FIG. 3D illustrates a fourth example PDCP data PDU format in accordance with some example embodiments of the present disclosure;

FIG. 3E illustrates a fifth example PDCP data PDU format in accordance with some example embodiments of the present disclosure;

FIG. 3F illustrates a sixth example PDCP data PDU format in accordance with some example embodiments of the present disclosure;

FIG. 4 illustrates an example signaling chart of a communication process in accordance with some example embodiments of the present disclosure;

FIG. 5 illustrates a flowchart of an example method implemented at a terminal device in accordance with some embodiments of the present disclosure;

FIG. 6 illustrates a flowchart of an example method implemented at a network device in accordance with some embodiments of the present disclosure;

FIG. 7 illustrates a simplified block diagram of a device that is suitable for implementing embodiments of the present disclosure.

Throughout the drawings, the same or similar reference numerals represent the same or similar element.

Through this document, the terms defined below may be referenced.

| | |
|---|---|
| 3GPP | 3rd generation partnership project |
| NR | New Radio Access |
| DCI | Downlink Control Information |
| XR | eXtended Reality |
| PDCCH | Physical Downlink Control CHannel |
| MACCE | MAC Control Element |
| RRC | Radio Resource Control |
| PSDB | PDU-Set Delay Budget |
| PSER | PDU-Set Error Rate |

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate, Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

In an example PDCP data PDU format in accordance with a legacy scheme in the field, the length of the PDCP data PDU format is N octets, and the format has a “PDCP SN” field, whose length is 12 bits. Specifically, the first octet contains, from left to right, a “D/C” field, three “R” (which is short for “reserved”) fields and the starting 4 bits of the “PDCP SN” field. The second octet contains the rest 8 bits of the “PDCP SN” field. The rest octets in the first format are used for containing data.

In another example PDCP data PDU format in accordance with a legacy scheme in the field, the length of the PDCP data PDU format is also N octets, and the format has a “PDCP SN” field, whose length is 18 bits. Specifically, the first octet contains, from left to right, a “D/C” field, five “R” fields and the starting 2 bits of the “PDCP SN” field. The second and third octets contain the rest 16 bits of the “PDCP SN” field, each field containing 8 bits respectively. The rest octets in the format are used for containing data.

In legacy systems, as described above, a PDCP data PDU format with 12 bits PDCP SN as well as a PDCP data PDU format with 18 bits PDCP SN are defined. The transmitting PDCP entity shall maintain a discardTimer to discard PDCP service data unit(s) (SDU(s)) when some condition is met. This timer is configured only for data radio bearers (DRBs). The duration of the timer is configured by upper layers. In the transmitter (or, in other words, in the transmitting PDCP entity), a new timer is started upon reception of an SDU from upper layer. When the discardTimer expires for a PDCP SDU, or the successful delivery of a PDCP SDU is confirmed by PDCP status report, the transmitting PDCP entity shall discard the PDCP SDU along with the corresponding PDCP data PDU. If the corresponding PDCP data PDU has already been submitted to lower layers, the discard is indicated to lower layers. For SRBs, when upper layers request a PDCP SDU discard, the PDCP entity shall discard all stored PDCP SDUs and PDCP PDUs.

In the same time, the receiving PDCP entity shall maintain a reordering timer (for example, with the name “t-Reordering”) for reorderding PDUs received at the receiving PDCP entity. The duration of the timer is configured by upper layers, except for the case of NR (New Radio) sidelink communication or sidelink Signaling Radio Bearer 4 (SRB4). For NR sidelink communication or sidelink SRB4, the t-Reordering timer is determined by the implementation of the terminal device. This timer is used to detect loss of PDCP data PDUs. If t-Reordering timer is running, the t-Reordering timer shall not be started additionally, i.e. only one t-Reordering timer per receiving PDCP entity is running at a given time.

In an example signaling flow of a handover process in accordance with a legacy scheme in the field, the source gNB (source network device) issues a Handover Request message to the target gNB (target network device) passing a transparent RRC container with necessary information to prepare the handover at the target gNB. The information includes at least the target cell ID, KgNB*, the C-RNTI of the terminal device in the source network device, RRM-configuration including inactive time of the terminal device, basic access strum (AS)-configuration including antenna Info (short for “information”) and DL Carrier Frequency, the current QoS flow to DRB mapping rules applied to the terminal device, the SIBI from the source network device, the capabilities of the terminal device for different radio access technologies (RATs), PDU session related information, and can include the measurement information reported by the terminal device including beam-related information if available. The PDU session related information includes the slice information and QoS flow level QoS profile(s). The source network device may also request a dual active protocol stack (DAPS) handover for one or more DRBs.

For DRBs configured with DAPS, the source gNB sends the EARLY STATUS TRANSFER message. The DL COUNT value conveyed in the EARLY STATUS TRANSFER message indicates PDCP SN and hyper frame number (HFN) of the first PDCP SDU that the source gNB forwards to the target gNB. The source gNB does not stop assigning SNs to downlink PDCP SDUs until it sends the SN STATUS TRANSFER message to the target gNB in step 8b.

In the U-Plane handling for handover, for radio link control-acknowledgement (RLC-AM) bearers, PDCP SN is maintained on a per DRB basis and the source gNB informs the target gNB about the next DL PDCP SN to allocate to a packet which does not have a PDCP sequence number yet (either from source gNB or from the UPF). For security synchronization, HFN is also maintained and the source gNB provides to the target gNB one reference HFN for the UL and one for the DL, i.e. HFN and corresponding SN. Further, for RLC-UM bearers, the PDCP SN and HFN are reset in the target gNB, unless the bearer is configured with DAPS handover.

Especially, for DAPS handover, both downlink operations and uplink operations are performed in PDU/SDU granularity.

In some communication systems, an application layer instance can produce units of information that can be used by another application layer instance, e.g. to construct a usable information and one example of such information unit can be a video frame. Dependent on its size and the maximum transmission unit (MTU) of the transport network, that information unit may need to be segmented and transferred in multiple transport units, e.g. multiple IP packets. When all segments are received, the receiving application layer instance uses the information unit. Hence the quality of experience (QoE) is dependent on the reception of the information unit rather than individual segments constituting it. Therefore, the forwarding treatment described by the QoS parameters needs to be associated with the information unit.

As a result, the legacy systems described above may not bring about good performance. To obtain good performance, for XR/media services, a group of packets are used to carry payloads of a PDU set (e.g. a frame, video slice/tile). In media layer, packets in such a PDU set are decoded and/or handled as a whole. For example, the frame/video slice may only be decoded in case all or certain amount of the packets carrying the frame/video slice are successfully delivered. For example, a frame within a group of pictures (GOP) can only be decoded by the client in case all frames on which that frame depends are successfully received. Hence the groups of packets within the PDU set have inherent dependency on each other in media layer. Without considering such dependencies between the packets within the PDU set, 5GS may perform a scheduling with low efficiency. For example, the 5GS may randomly drop packet(s) but try to deliver other packets of the same PDU set which are useless to the client and thus waste radio resources.

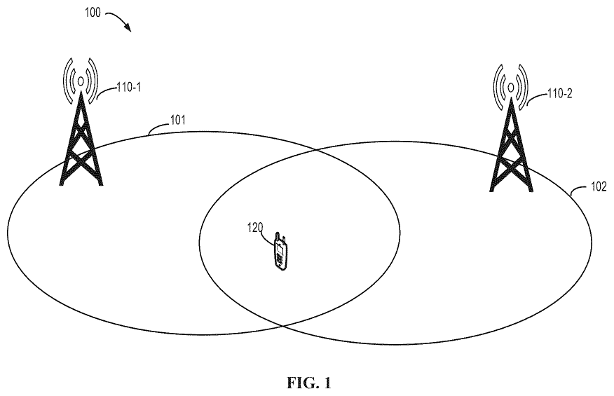

In view of the above issues, this document introduces methods, devices, and a computer readable medium for communication to achieve better communication quality and network performance, especially for XR services. Such solutions will be described in detail below with reference to FIGS. 1-7.

FIG. 1 illustrates an example communication system 100 in which some embodiments of the present disclosure can be implemented. The communication system 100, which is a part of a communication network, includes network devices 110-1 and 110-2 and a terminal device 120. In the following, the network device 110-1 may be referred to as a first network device (or, “a source network device”), and the network device 110-2 may be referred to as a second network device (or, “a target network device”). The network devices 110-1 and 110-2 may be collectively referred to as “network device 110” or “gNB 110” or individually referred to as a “network device 110” or “gNB 110”.

As illustrated in FIG. 1, the network device 110-1 has a coverage area comprising cell 101, and the terminal device 120 camps on the cell 101 and are served by the network device 110-1. The network device 110-2 has a coverage area comprising cell 102. In other words, the network device 110-1 provides network connection to the terminal device 120.

In the system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting TX device (or a transmitter) and the network device 110 is a RX device (or a receiver). It is to be understood that the network device 110 may provide one or more serving cells. In some embodiments, the network device 110 can provide multiple cells.

The network device 110-1 can provide services to the terminal device 120, and the network device 110-1 and the terminal device 120 may communicate data and control information with each other. In other words, the network device 110-1 is the serving network device for the terminal device 120.

The communications in the communication system 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the number of devices and their connection relationships and types shown in FIG. 1 are for illustrative purposes only without suggesting any limitation. The communication system 100 may comprise any suitable number of network device(s) and terminal device(s) adapted for implementing embodiments of the present disclosure.

It is to be noted that:

The term “PDU set” in this disclosure refers to, for example, a PDU set is composed of one or more PDUs carrying the payload of one unit of information generated at the application level (e.g. a frame or video slice for XRM Services, as used in 3GPP TR 26.926 [27]). In some implementations all PDUs in a PDU set are needed by the application layer to use the corresponding unit of information. In other implementations, the application layer can still recover part or entire of the information unit, when some PDUs are missing.

The term “Data Burst” in this disclosure refers to, for example, a set of data comprising multiple PDUs generated and sent by the application in a short period of time. It is to be noted that a Data Burst can be composed by one or multiple PDU sets.

The term “PSDB” in this disclosure refers to, for example, the PDU Set Delay Budget (PSDB) which defines an upper bound for the time that a PDU set may be delayed between the terminal device 120 and the N6 termination point at the user-plane function (UPF). PSDB applies to the DL PDU set received by the UPF over the N6 interface, and to the UL PDU set sent by the terminal device 120.

The term “PSER” in this disclosure refers to, for example, the PDU Set Error Rate (PSER) which defines an upper bound for the rate of PDU sets (e.g. set of IP packets constituting a PDU set) that have been processed by the sender of a link layer protocol (e.g. radio link access (RLC) in RAN of a 3GPP access) but where all of the PDUs in the PDU set are not successfully delivered by the corresponding receiver to the upper layer (e.g. PDCP in RAN of a 3GPP access). Thus, the PSER defines an upper bound for a rate of non-congestion related packet losses. The purpose of the PSER is to allow for appropriate link layer protocol configurations (e.g. RLC and hybrid automatic repeat request (HARQ) in RAN of a 3GPP access).

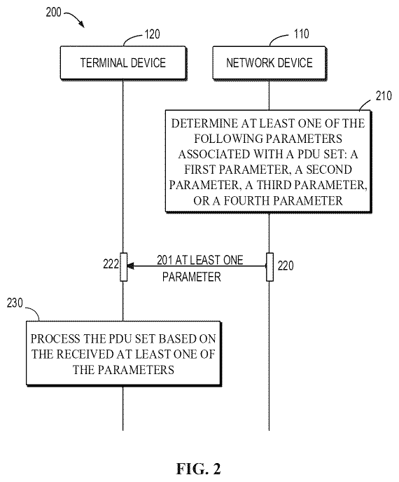

FIG. 2 illustrates an example signaling chart illustrating a communication process 200 in accordance with some example embodiments of the present disclosure. Only for the purpose of discussion, the communication process 200 will be described with reference to FIG. 1. The communication process 200 may involve the terminal device 120 and the network device 110.

In some example embodiments, the network device 110 determines at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set.

For example, for control plane, the network device 110 can determine 210 at least one of the following parameters to the terminal device 120 by RRC signaling, as illustrated in FIG. 2:
whether all PDUs belonging to a PDU set are needed: Based on this parameter, the receiving PDCP entity can determine whether to discard all PDUs belonging to a PDU set if at least one PDU of the PDU set is lost.
when a high-priority (or associated) PDU set is lost/discarded, whether other PDU sets associated with this PDU set should be discarded.
PDU Set discard timer (for example, with the name “discardTimer”): This timer is configured only for DRBs. In the transmitting PDCP entity, a new PDCP set discard timer is started upon first reception of a PDU of a PDCP set from upper layer. When this timer expires, the terminal device 120 will discard all PDUs belonging to the corresponding PDU set and/or all PDUs of other PDU sets associated with this PDU set. All PDUs in the same PDU set share the same PDU Set discard timer.
PDU Set reordering timer (for example, with the name “t-Reordering”): This timer is configured only for DRBs. This timer is used to detect loss of PDCP data PDU(s) belonging to the corresponding PDU set.

Additionally, in some example embodiments, the network device 110 transmits, to a terminal device 120, the at least one of the parameters.

For example, for control plane, the network device 110 may transmit 220 the at least one of the parameters (denoted as 201 in FIG. 2) to the terminal device 120 (for example, by RRC signaling), as illustrated in FIG. 2.

On the other side of communication, the terminal device 120 receives 222 the at least one parameter 201. With the received parameter(s), the terminal device 120 can be configured with such parameter(s).

Additionally, in some example embodiments, the terminal device 120 processes the PDU set based on the received at least one of the parameters 201.

For example, the terminal device 120 may process 230 (for example, dropping/discarding a PDU set) the PDU set based on the received at least one of the parameters 201.

To facilitate the terminal device 120 to process the PDU set, several fields can be defined in the PDCP data PDU. In some example embodiments, packets from a higher layer are organized in unit of PDU set in the PDCP layer, and PDU set information is sent in band in PDCP header of each PDU in a PDU set.

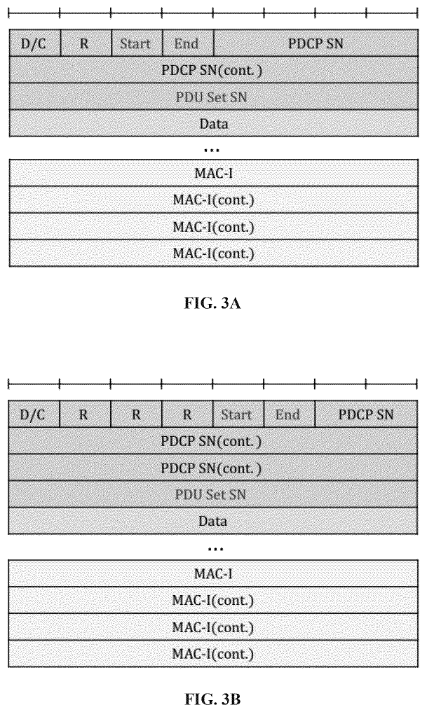

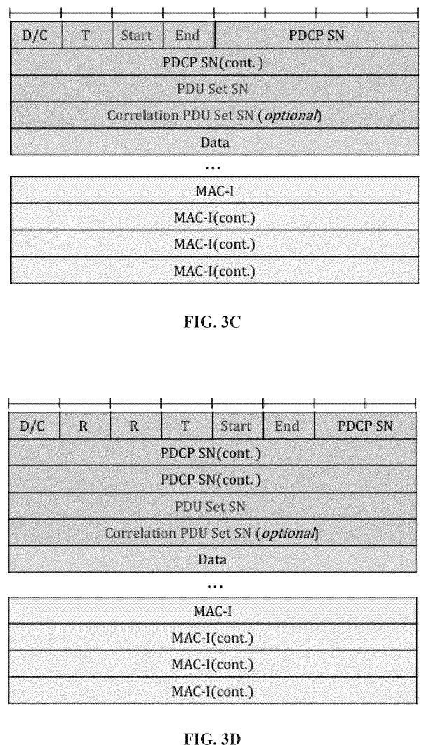

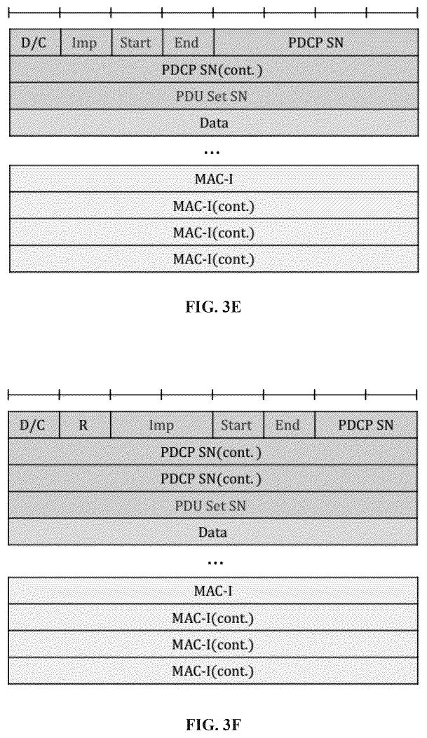

For example, from the examples illustrated in FIGS. 3A-3F, it can be seen that, packets from a higher layer are organized in unit of PDU set in the PDCP layer, and PDU set information is sent in band in PDCP header of each PDU in a PDU set. This will be described in detail with reference to FIGS. 3A-3F.

FIG. 3A illustrates an example PDCP data PDU format (hereafter referred to as “first format”) in accordance with some example embodiments of the present disclosure.

In some example embodiments, at least one of the following fields is defined in the header of a PDCP data PDU: a first field indicating the serial number (SN) of the PDU set to which the PDCP data PDU belongs; a second field indicating whether the PDCP data PDU is the first PDU of the PDU set to which it belongs; or a third field indicating whether the PDCP data PDU is the last PDU of the PDU set to which it belongs.

For example, a PDCP Data PDU format with 12 bits PDCP SN (for PDU set) is illustrated in FIG. 3A. According to the first format, at least one of the following fields can be defined in the header of PDCP data PDU:

“PDU set SN” field: This field indicates the SN of the PDU set to which the PDCP data PDU belongs.

“Start Indication” field: This field indicates whether the PDCP data PDU is the first PDU of the PDU set to which it belongs. If the value for this field is set to “0”, it indicates that the PDCP data PDU is not the first PDU of the PDU set to which it belongs. If the value for this field is set to “1”, it indicates that the PDCP data PDU is the first PDU of the PDU set to which it belongs.

“End Indication” field: This field indicates whether this PDCP data PDU is the last PDU of the PDU set to which it belongs. If the value for this field is set to “0”, it indicates that this PDCP data PDU is not the last PDU of the PDU set to which it belongs. If the value for this field is set to “1”, it indicates that this PDCP data PDU is the last PDU of the PDU set to which it belongs.

In some example embodiments, each of the second field and the third field uses one bit in the PDCP header. For example, as illustrated in FIG. 3A, the “Start Indication” field and the “End Indication” field may use one reserved bit in the PDCP header, respectively.

Additionally or alternatively, the length of the “PDU Set SN” field may be one octet, i.e., 8 bits, as illustrated in FIG. 3A.

FIG. 3B illustrates another example PDCP data PDU format (hereafter referred to as “second format”) in accordance with some example embodiments of the present disclosure.

In some example embodiments, at least one of the following fields is defined in the header of a PDCP data PDU: a first field indicating the serial number (SN) of the PDU set to which the PDCP data PDU belongs; a second field indicating whether the PDCP data PDU is the first PDU of the PDU set to which it belongs; or a third field indicating whether the PDCP data PDU is the last PDU of the PDU set to which it belongs.

For example, a PDCP data PDU format with 18 bits PDCP SN (for PDU set) is illustrated in FIG. 3B. According to the second format, at least one of the following fields shall be defined in the header of PDCP data PDU: “PDU Set SN” field, “Start Indication” field, and “End Indication” field.

Like the example illustrated in FIG. 3A, in the example illustrated in FIG. 3B, the second field (“Start Indication” field) and the third field (“End Indication” field) may also use one reserved bit in the PDCP header, respectively. Additionally or alternatively, the length of the “PDU Set SN” field may be one octet, i.e., 8 bits, as illustrated in FIG. 3B.

FIG. 3C illustrates an example PDCP data PDU format (hereafter referred to as “third format”) in accordance with some example embodiments of the present disclosure. Only for the purpose of discussion, the third format will be described with reference to FIG. 3A.

In some example embodiments, at least one of the following fields is further defined in the header of a PDCP data PDU: a fourth field indicating the SN of other PDU sets, wherein the PDU set to which the PDCP data PDU belongs is associated with PDU set specified by the field; a fifth field indicating whether the fourth field exists in the header of PDCP data PDU; or a sixth field indicating the importance or priority of the PDU set.

For example, a PDCP data PDU format with 12 bits PDCP SN (for PDU set) is illustrated in FIG. 3C. According to the third format, at least one of the following fields can be further defined in the header of PDCP data PDU:

“Correlation PDU Set SN” field (optional): This field indicates the SN of other PDU sets, and the PDU set to which the PDCP data PDU belongs is associated with PDU set specified by this field. For example, if at least one PDU of PDU Set indicated by “Correlation PDU Set SN” field is lost/discarded, the PDU set to which this PDCP data PDU belongs shall be discarded/dropped too.

“T” field (optional): This field indicates whether “Correlation PDU Set SN” field exists in the PDCP header. If the value for the “T” field is set to 0, it indicates that the “Correlation PDU Set SN” field does not exist in the PDCP header. If the value for the “T” field is set to 1, it indicates that the “Correlation PDU Set SN” field exists in the PDCP header.

“PDU Set importance level information” field (or priority or PDU Set type, optional): This field carries the importance or priority information of the PDU set. For example, the importance levels (or priority) of the PDU sets corresponding to the I frame (short for “Independent frame”, which is a single frame of digital content that the compressor examines independent of the frames that precede and follow it and stores all of the data needed to display that frame) and the P frame (short for “Predicted frame”, which holds only the changes in the image from the previous frame) are different. The importance level (or priority) of the PDU sets corresponding to the base layer (BL) and enhanced layer (EL) are different, and so on.

In some example embodiments, the fifth field uses one bit in the PDCP header. In response to that the fifth field indicates that the fourth field exists in the PDCP header, the fourth field is newly added to the PDCP header.

For example, the fifth field (“T” field) reuses a reserved bit in the PDCP header. A “T” field set to 1 may indicate “Correlation PDU Set SN” field exists in the PDCP header, while a “T” field set to 0 may indicate “Correlation PDU Set SN” field exists in the PDCP header. In this case, in response to that the “T” field indicates that the fourth field (i.e., “Correlation PDU Set SN” field) exists in the PDCP header (i.e., the “T” field is set to 1), the fourth field is newly added to the PDCP header.

FIG. 3D illustrates another example PDCP data PDU format (hereafter referred to as “fourth format”) in accordance with some example embodiments of the present disclosure. Only for the purpose of discussion, the fourth format will be described with reference to FIG. 3B.

For example, a PDCP data PDU format with 18 bits PDCP SN (for PDU set) is illustrated in FIG. 3D. According to the fourth format, at least one of the following fields can be defined in the header of PDCP data PDU: “Correlation PDU Set SN” field (optional), “T” field (optional), and “PDU Set importance level information” field.

In some example embodiments, the fifth field uses one bit in the PDCP header. In response to that the fifth field indicates that the fourth field exists in the PDCP header, the fourth field is newly added to the PDCP header.

For example, the fifth field (“T” field) reuses a reserved bit in the PDCP header. A “T” field set to 1 may indicate “Correlation PDU Set SN” field exists in the PDCP header, while a “T” field set to 0 may indicate “Correlation PDU Set SN” field exists in the PDCP header. In this case, in response to that the “T” field indicates that the fourth field (i.e., “Correlation PDU Set SN” field) exists in the PDCP header (i.e., the “T” field is set to 1), the fourth field is newly added to the PDCP header.

FIG. 3E illustrates an example PDCP data PDU format (hereafter referred to as “fifth format”) in accordance with some example embodiments of the present disclosure. Only for the purpose of discussion, the fifth format will be described with reference to FIG. 3A.

For example, a PDCP data PDU format with 12 bits PDCP SN (for PDU Set) is illustrated in FIG. 3E. According to the fifth format, compared with the first format, an “Imp” field indicating PDU set importance level information is further defined in the header of the PDCP data PDU. As described above, this field carries the importance or priority information of the PDU set. For example, the importance levels (or priority) of the PDU Sets corresponding to the I frame and the P frame are different. The importance level (or priority) of the PDU sets corresponding to the BL layer and EL layer are different, and so on.

In some example embodiments, the sixth field uses at least one bit in the PDCP header.

For example, as illustrated in FIG. 3E, the sixth field (“PDU Set importance level information” field, or simply “Imp” field as illustrated in FIG. 3E) reuses a reserved bit in the PDCP header as illustrated in FIG. 3A.

FIG. 3F illustrates another example PDCP data PDU format (hereafter referred to as “sixth format”) in accordance with some example embodiments of the present disclosure. Only for the purpose of discussion, the sixth format will be described with reference to FIG. 3B.

For example, a PDCP data PDU format with 18 bits PDCP SN (for PDU set) is illustrated in FIG. 3F. According to the sixth format, compared with the second format, an “Imp” field indicating PDU set importance level information is further defined in the header of the PDCP data PDU. As described above, this field carries the importance or priority information of the PDU set. For example, the importance levels (or priority) of the PDU sets corresponding to the I frame and the P frame are different. The importance level (or priority) of the PDU sets corresponding to the BL layer and EL layer are different, and so on.

In some example embodiments, the sixth field uses at least one bit in the PDCP header.

For example, the sixth field (“PDU Set importance level information” field, or simply “Imp” field as illustrated in FIG. 3E) reuses a reserved bit in the PDCP header.

In some example embodiments, the terminal device further determines the range of count or PDCP SN that belongs to a PDU set to be from a first count or a first PDCP SN to a second count or a second PDCP SN, the first count or the first PDCP SN being a count or a PDCP SN of a PDCP data PDU whose second field is set to 1, the second count or the second PDCP SN being a count or a PDCP SN of a PDCP data PDU whose third field is set to 1; and determines whether a PDCP set loses at least one PDU based on the PDU set SN, the count or PDCP SN, information about the second field and the third field.

For example, in the examples illustrated in FIGS. 3A-3F, the range of COUNT (or PDCP SN) that belongs to a PDU set is [the COUNT (or PDCP SN) of the PDCP data PDU whose Start Indication field is set to 1, the COUNT (or PDCP SN) of the PDCP data PDU whose End Indication field is set to 1]. The terminal device 120 and/or the network device 110 can determine whether a PDCP set loses any PDUs according to the “PDU Set SN”, COUNT (or “PDCP SN”), “Start Indication”, and “End Indication” fields.

In this case, If PDCP data PDU with “Start Indication” field set to 1 or “End Indication” field set to 1 is not received for a PDU set, it then can be inferred that the PDCP set has lost at least one PDU.

Further, if a PDCP data PDU with “Start Indication” field set to 1 and a PDCP data PDU with “End Indication” field set to 1 are received for a PDU set, then PDCP receiving entity knows the COUNT (or PDCP SN) range of the PDU set based on the these PDCP data PDUs. If any PDCP PDU within the range is lost, receiving PDCP entity could know a PDU set has lost at least one PDU.

In this way, based on the PDCP data PDU structure (for example, as illustrated in FIGS. 3A-3F), PDCP SN (or COUNT) value is continuous as legacy, and the existing COUNT-based procedure (such as ciphering/integrity protection/reordering, etc.) can be reused. At the same time, PDU set-related procedures can be performed based on the legacy COUNT-based procedures, such as PDU set-based discarding, judging whether any PDUs of a PDU set are lost, etc.

In some example embodiments, at first reception of a PDCP SDU belonging to a PDU set from upper layer, a transmitting PDCP entity (for example, in the terminal device 120) starts a discard timer associated with the PDU set; and discarding, when the discard timer expires for the SDU set, PDUs and/or SDUs belonging to the corresponding PDU set and/or PDUs and/or SDUs of other PDU sets associated with the PDU set. Here, PDUs in the same PDU set share the same discard timer.

For example, in the PDU set discard timer based drop/discard scenario, a PDU set discard timer (for example, with the name “discardTimer”) is defined as a timer configured only for DRBs. All PDUs in the same PDU set share the same PDU set discard timer. At first reception of a PDCP SDU belonging to a PDCP set from upper layer, the transmitting PDCP entity (for example, in the terminal device 120) shall start the PDU set discard timer associated with this PDU set (if configured). When the PDU set discard timer expires for a PDU set, the transmitting PDCP entity shall discard all PDU/SDUs belonging to the corresponding PDU set and/or all PDU/SDUs of other PDU sets associated with this PDU set. If the corresponding PDCP data PDU has already been submitted to lower layers, the discard is indicated to lower layers. For example, if PDU set N (the PDU set has a set index “N”) is discarded, transmitting PDCP entity shall discard the PDU set(s) whose “Correlation PDU Set SN” field is equal to N too.

There are two alternatives to buffer the data belonging to a PDU set. One way is that all PDCP SDUs of a PDU set are delivered to upper layers only when all PDUs belonging to the PDU set are received. Otherwise, data of the PDU set shall be stored in the reception buffer for reordering. The other way is that, only data that is out of order shall be stored in the reception buffer as legacy.

In some example embodiments, at first reception of a PDU belonging to a PDU set from a lower layer, the receiving PDCP entity (for example, in the terminal device 120) starts the reordering timer associated with the PDU set; and discarding, when the reordering timer expires for the SDU set, PDUs and/or SDUs belonging to the corresponding PDU set and/or PDUs and/or SDUs of other PDU sets associated with the PDU set. Here, PDUs in the same PDU set share the same reordering timer.

For example, a PDU set t-Reordering timer is defined as the reordering timer for the PDU set, and is configured by RRC signaling. This timer is configured only for DRBs, and is used to detect loss of PDCP data PDU(s) belonging to the corresponding PDU set.

All PDUs in the same PDU set share the same PDU set t-Reordering timer. In the receiving PDCP entity (for example, in the terminal device 120), a new PDCP PDU set reordering timer (namely, the t-Reordering timer) is started upon first reception of a PDCP PDU belonging to a PDCP set from lower layer. When the PDU set t-Reordering expires for a PDU set, and at least one PDU/SDU of a PDCP Set is lost, receiving PDCP entity shall discard all PDU/SDUs belonging to this PDU set and/or all PDU/SDUs of other PDU sets associated with this PDU set. For example, if PDU set N (the PDU set whose set index is “N”) is lost, the receiving PDCP entity shall discard the PDU set(s) whose “Correlation PDU Set SN” field is equal to N too.

Specifically, in this case, based on the above description, the following processing flow may be performed.

```
If the received PDCP Data PDU with COUNT value =
RCVD_COUNT is not discarded above, the receiving PDCP entity shall:
  ...
  - if RCVD_COUNT = RX_DELIV:
```

| | |
|---|---|
| - | deliver to upper layers in ascending order of the associated |
| | COUNT value after performing header decompression, if not |
| | decompressed before; |
| | - all stored PDCP SDU(s) with consecutively associated |
| | COUNT value(s) starting from COUNT = RX_DELIV; |
| - | update RX_DELIV to the COUNT value of the first PDCP SDU |
| | which has not been delivered to upper layers, with COUNT value |
| | > RX_DELIV; |

- if RX_DELIV >= RX_REORD:

| | |
|---|---|
| - | stop PDU Set t-Reordering of the PDU Set(s) whose last |
| | PDU(or SDU) with COUNT value < RX_DELIV (if running). |

Actions when a PDU Set t-Reordering expires

When a PDU Set t-Reordering expires, the receiving PDCP entity shall:

| | |
|---|---|
| - | discard all PDU/SDUs belonging to the corresponding PDU set |
| | and/or all PDU/SDUs of other PDU sets associated with this PDU set. |

...

| | |
|---|---|
| - | update RX_DELIV to the COUNT value of the first PDCP SDU |
| | which has not been discarded and has not been delivered to upper |
| | layers, with COUNT value >= RX_REORD; |
| - | if RX_DELIV < RX_NEXT: |
| | - update RX_REORD to RX_NEXT; |

S Additionally or alternatively, the following processing flow may be performed.

When upper layers request a PDCP entity suspend, the receiving PDCP
entity shall:
- if t-Reordering or PDU Set t-Reordering is running:

| | |
|---|---|
| - | stop and reset t-Reordering or PDU Set t-Reordering; |
| - | deliver all stored PDCP SDUs to the upper layers in ascending |
| | order of associated COUNT values after performing header |
| | decompression; |

- set RX_NEXT and RX_DELIV to the initial value.

```
When the value of the t-Reordering or PDU Set t-Reordering is
reconfigured by upper layers while the t-Reordering or PDU Set t-
Reordering is running, the receiving PDCP entity shall:
  - update RX_REORD to RX_NEXT;
  - stop and restart t-Reordering or PDU Set t-Reordering .
```

Specifically, in some example embodiments, the receiving PDCP entity in the terminal device 120 further stops and resets the reordering timer if the reordering timer is running, when requested by upper layer to suspend transmission of the PDU set.

For example, when upper layers request a PDCP entity to suspend (transmission of PDU sets), the receiving PDCP entity (for example, in the terminal device 120) shall:
if t-Reordering or PDU Set t-Reordering is running:
   stop and reset t-Reordering or PDU Set t-Reordering;
   deliver all stored PDCP SDUs to the upper layers in ascending order of associated COUNT values after performing header decompression;
set RX_NEXT and RX_DELIV to the initial value.

In some other example embodiments, the receiving PDCP entity in the terminal device 120 further stops and restarts the reordering timer while the reordering timer is running, when the value of the reordering timer is configured by upper layer.

For example, when upper layers request a PDCP entity to suspend, the receiving PDCP entity (for example, in the terminal device 120) shall:

when the value of the PDU Set t-Reordering is reconfigured by upper layers while the PDU Set t-Reordering is running, the receiving PDCP entity in the terminal device 120 shall:
update RX_REORD to RX_NEXT;
stop and restart PDU Set t-Reordering.

In some example embodiments, the transmitting PDCP entity in the terminal device 120 discards, when a discard timer expires for a PDCP SDU, PDUs and/or SDUs belonging to the corresponding PDU set and/or PDUs and/or SDUs of other PDU sets associated with the PDU set.

For example, when the discardTimer expires for a PDCP SDU, the transmitting PDCP entity (for example, in the terminal device 120) shall discard all PDU/SDUs belonging to the corresponding PDU set and/or all PDU/SDUs of other PDU sets associated with this PDU set. If the corresponding PDCP data PDU has already been submitted to lower layers, the discard is indicated to lower layers.

In some example embodiments, the receiving PDCP entity (for example in the terminal device 120) discards, when a reordering timer expires for a PDCP SDU, PDUs and/or SDUs belonging to the corresponding PDU set and/or PDU/SDUs of other PDU sets associated with the PDU set, in response to that it is configured that all PDUs in a PDU set are needed by an application layer, and at least one PDU and/or SDU of a PDCP set is lost.

For example, if all PDUs belonging to a PDU set are needed by application layer is configured by RRC signaling, and at least one PDU/SDU of a PDCP set is lost when t-Reordering expires, receiving PDCP entity (for example, in the terminal device 120) shall discard all PDU/SDUs belonging to this PDU set and/or all PDU/SDUs of other PDU sets associated with this PDU set.

The following description introduces how to handle PDU set information during handover procedure.

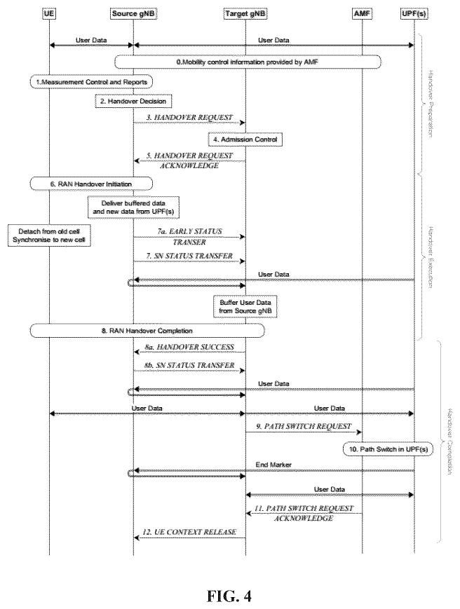

FIG. 4 illustrates an example signaling chart of a communication process 400 in accordance with some example embodiments of the present disclosure. Only for the purpose of discussion, the process 400 will be described with reference to FIG. 1. Specifically, the communication process 400 may be a handover process and may involve the terminal device 120, a source network device 110-1 and a target network device 110-2.

In the communication process 600 which is a handover process, as mentioned above, it is assumed that the network device 110-1 is a source network device who currently provides network service to the terminal device 120, and the network device 110-2 is a target network device who may provide network service to the terminal device 120 since the time point of the handover while the source network device 110-1 on longer provides network service to the terminal device 120 since the time point of the handover. In other words, network service to the terminal device 120 may be “handed over” from the source network device 110-1 to the target network device 110-2.

In some example embodiments, during a handover execution period, the terminal device 120 further maintains common PDU Set SN allocation. Here, the PDU Set SN continuity is supported for both RLC-AM and unacknowledgement (UM) DRBs configured with DAPS.

In some example embodiments, the source network device 110-1 further transmits, to the target network device 110-2, a message for handover request passing information to prepare the handover to the target network device. The information comprises at least PDU set related information. The PDU set related information comprises information about at least the first parameter and the second parameter.

In some example embodiments, the source network device 110-1 further maintains, for RLC-AM bearers, PDU set serial number (SN); and transmits, to the target network device, the next PDU Set SN to allocate to a packet which does not have a PDU Set SN.

In some example embodiments, the source network device 110-1 further transmits, to the target network device 110-2, information about at least one of the following: the first field, the second field, the third field, or size of the PDU set.

In some example embodiments, the source network device 110-1 further transmits, to the target network device 110-2, information about importance level or priority, or associated PDU set.

In some example embodiments, the source network device 110-1 further sends, when DRBs are configured with DAPS, to the target network device 110-2, a message for early status transfer. The PDU Set SN and/or a value for downlink count conveyed in the message indicates PDU set SN, PDCP SN and HEN of the first PDCP SDU that the source network device 110-1 forwards to the target network device 110-2.

In some example embodiments, the source network device 110-1 further assigns SNs and/or PDU Set SNs to downlink PDCP SDUs, until the source network device 110-1 sends a message for SN status transfer to the target network device 110-2.

In some example embodiments, the message for SN status transfer indicates, to the target network device 110-2, the PDU Set SN and count of the first missing PDCP SDU the target network device 110-2 should start delivering.

In some example embodiments, the source network device 110-1 further allocating downlink PDCP SNs and/or PDU Set SNs until the SN assignment is handed over to the target network device 110-2; scheduling downlink data on the source radio link and starting forwarding downlink PDCP SDUs along with assigned PDCP SNs and/or PDU Set SNs to the target network device 110-2, upon allocation of downlink PDCP SNs and/or PDU Set SNs by the source network device 110-1; and maintaining, after the SN assignment is handed over to the target network device 110-2, PDU Set SN, HFN and PDCP SN.

In some example embodiments, the source network device 110-1 further transmits, to the target network device 110-2, information about at least one of: the first field, the second field, the third field, or size of the PDU set.

In some example embodiments, the source network device 110-1 further transmits, to the target network device 110-2, information about importance level or priority, or associated PDU set.

In some example embodiments, the source network device 110-1 further transmits, to the target network device 110-2, a message for handover request comprising PDU set related information, the PDU set related information comprising information about at least the first parameter and the second parameter; and transmitting a message for SN status transfer to the target network device 110-2.

In some example embodiments, the source network device 110-1 further requests a DAPS handover for one or more DRBs; and transmits, for DRBs configured with DAPS, to the target network device 110-2, a message for early status transfer. The message comprises a PDU set SN and/or a value for downlink count indicating PDU set SN, PDCP SN and HFN of the first PDCP SDU that the source network device 110-1 forwards to the target network device 110-2.

In some example embodiments, for DRBs not configured with DAPS, the source network device 110-1 further transmits a message for SN status transfer to the target network device 110-2.

In some example embodiments, the target network device 110-2 further receives, from the source network device 110-1, a message for handover request passing information to prepare the handover at the target network device 110-2. The information comprises at least PDU set related information. The PDU set related information comprises information about at least the first parameter and the second parameter.

In some example embodiments, upon determining that the radio link control-acknowledgement (RLC-UM) bearer is configured with DAPS handover, for RLC-UM bearers, the target network device 110-2 further resets PDU set SN, PDCP SN and HFN.

As illustrated in FIG. 4, in step 3, the source gNB (i.e., the source network device 110-1) issues a Handover Request message to the target gNB (i.e., the target network device 110-2) passing a transparent RRC container with necessary information to prepare the handover at the target side. The information includes at least the target cell ID, KgNB*, the C-RNTI of the terminal device 120 in the source network device 110-1, RRM-configuration including inactive time of the terminal device 120, basic AS-configuration including antenna Info and DL Carrier Frequency, the current QoS flow to DRB mapping rules applied to the terminal device 120, the SIBI from the source network device 110-1, the capabilities of the terminal device 120 for different RATs, PDU session related information, PDU set related information (optional, this info may be in QoS profile), and can include the UE reported measurement information reported including beam-related information if available. The PDU session related information includes the slice information and QoS flow level QoS profile(s). The PDU set related information includes whether all PDUs are needed for a PDU set and whether/how to drop PDUs, etc. The source gNB may also request a DAPS handover for one or more DRBs.

Also as illustrated in FIG. 4, in step 7a, for DRBs configured with DAPS, the source gNB (i.e., the source network device 110-1) sends the EARLY STATUS TRANSFER message. The PDU Set SN/DL COUNT value conveyed in the EARLY STATUS TRANSFER message indicates PDU Set SN, PDCP SN and HFN of the first PDCP SDU that the source gNB (i.e., the source network device 110-1) forwards to the target gNB (i.e., the target network device 110-2). The source gNB does not stop assigning SNs/PDU Set SNs to downlink PDCP SDUs until it sends the SN STATUS TRANSFER message to the target gNB in step 8b.

In step 7, for DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e. for RLC-AM). The uplink PDCP SN receiver status includes at least the PDCP SN of the first missing UL PDCP SDU and may include a bitmap of the receive status of the out of sequence UL PDCP SDUs that the terminal device 120 needs to retransmit in the target cell (associated with the target gNB), if any. The downlink PDCP SN transmitter status indicates the next PDCP SN that the target gNB) shall assign to new PDCP SDUs, not having a PDCP SN yet.

In the U-Plane handling for handover, for RLC-AM bearers, for in-sequence delivery and application duplication, PDCP SN is maintained on a per DRB basis and the source gNB informs the target gNB about the next DL PDCP SN to allocate to a packet which does not have a PDCP sequence number yet (either from source gNB or from the UPF). For security synchronization, HFN is also maintained and the source gNB provides to the target gNB one reference HFN for the UL and one for the DL, i.e. HFN and corresponding SN. The source gNB may inform the target gNB about at least one of: “PDU Set SN”, “Start indication”, “End indication”, or size of the PDU Set(s). Specifically, PDU Set SN is maintained and the source gNB informs the target gNB about the next PDU Set SN to allocate to a packet which does not have a PDU Set SN yet (either from source gNB or from the UPF). The source gNB may also inform the target gNB about “Start indication”/“End indication” and/or size of the PDU Set(s). If needed, importance level (or priority, or PDU Set Type) or “Correlation PDU Set SN” shall be informed from source gNB to target gNB too. Further, for RLC-UM bearers, the PDU Set SN, PDCP SN and HFN are reset in the target gNB, unless the bearer is configured with DAPS handover.

In some example embodiments, for DAPS handover, both downlink operations and uplink operations are performed in PDU set granularity.

In one example, for downlink processing, the source gNB is responsible for allocating downlink PDCP SNs/PDU Set SNs until the SN assignment is handed over to the target gNB 110-2 and data forwarding takes place. That is, the source gNB does not stop assigning PDCP SNs/PDU Set SNs to downlink packets until it receives the HANDOVER SUCCESS message and sends the SN STATUS TRANSFER message to the target gNB. Upon allocation of downlink PDCP SNs/PDU Set SNs by the source gNB, it starts scheduling downlink data on the source radio link and also starts forwarding downlink PDCP SDUs along with assigned PDCP SNs/PDU Set SNs to the target gNB. For security synchronization, HFN is maintained for the forwarded downlink SDUs with PDCP SNs assigned by the source gNB. The source gNB sends the EARLY STATUS TRANSFER message to convey the DL COUNT value, indicating PDCP SN and HFN of the first PDCP SDU that the source gNB forwards to the target gNB. PDU Set SN, HFN and PDCP SN are maintained after the SN assignment is handed over to the target gNB. The SN STATUS TRANSFER message indicates the next DL PDCP SN/PDU Set SN to allocate to a packet which does not have a PDCP sequence number/PDU Set SN yet, even for RLC-UM. “Start indication”/“End indication” and/or size of a PDU Set may also be handed over to the target gNB. If needed, importance level (or priority, or PDU Set Type) or “Correlation PDU Set SN” shall be informed from source gNB to target gNB.

In another example, for uplink processing, during handover execution period, the UE maintains separate security context and ROHC header compressor context for uplink transmissions towards the source gNB and target gNB. The UE maintains common UL PDCP SN/PDU Set SN allocation. PDCP SN/PDU Set SN continuity is supported for both RLC-AM and UM DRBs configured with DAPS. PDU Set SN, HFN and PDCP SN are maintained in the target gNB. The SN STATUS TRANSFER message indicates the PDU Set SN and COUNT of the first missing PDCP SDU that the target should start delivering to the 5GC, even for RLC-UM.

In this way, packet processing with PDU set granularity is supported, and PDU-set based handling is also supported. Therefore, processing of XR/media services can be performed in PDU set granularity instead of in PDU granularity. At the same time, the processing of each data packet in the QoS flow is no longer relatively independent; but rather, PDU set(s) which is (are) dependent on other PDU set(s) can be processed (for example, dropped/discarded) based on the other PDU set(s). As a result, communication quality and network performance are improved.

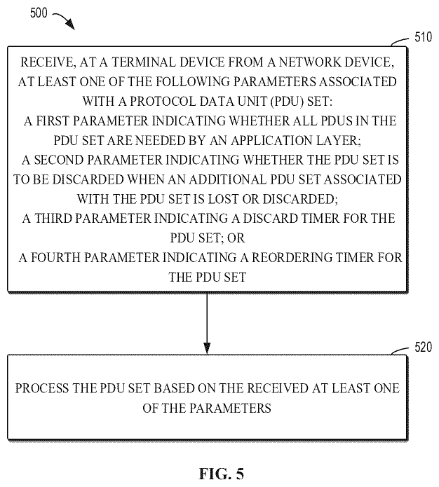

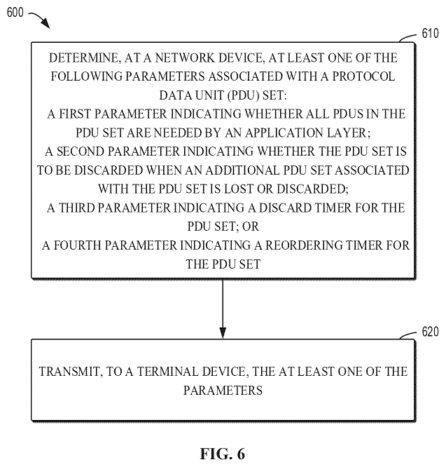

FIG. 5 illustrates a flowchart of an example method 500 implemented at a terminal device in accordance with some embodiments of the present disclosure. For the purpose of discussion, the method 500 will be described from the perspective of the terminal device 120 with reference to FIG. 1.

At block 510, the terminal device 120 receives, from the network device 110, at least one of the following parameters associated with a PDU set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set. At block 520, the terminal device 120 processes the PDU set based on the received at least one of the parameters.

In some example embodiments, at least one of the following fields is defined in the header of a PDCP data PDU: a first field indicating the SN of the PDU set to which the PDCP data PDU belongs; a second field indicating whether the PDCP data PDU is the first PDU of the PDU set to which it belongs; or a third field indicating whether the PDCP data PDU is the last PDU of the PDU set to which it belongs.

In some example embodiments, at least one of the following fields is further defined in the header of a PDCP data PDU: a fourth field indicating the SN of other PDU sets, wherein the PDU set to which the PDCP data PDU belongs is associated with PDU set specified by the field; a fifth field indicating whether the fourth field exists in the header of PDCP data PDU; or a sixth field indicating the importance or priority of the PDU set.

In some example embodiments, the terminal device further determines the range of count or PDCP SN that belongs to a PDU set to be from a first count or a first PDCP SN to a second count or a second PDCP SN, the first count or the first PDCP SN being a count or a PDCP SN of a PDCP Data PDU whose second field is set to 1, the second count or the second PDCP SN being a count or a PDCP SN of a PDCP Data PDU whose third field is set to 1; and determines whether a PDCP set loses at least one PDU based on the PDU set SN, the count or PDCP SN, information about the second field and the third field.

In some example embodiments, each of the second field and the third field uses one bit in the PDCP header.

In some example embodiments, the fifth field uses one bit in the PDCP header. In response to that the fifth field indicates that the fourth field exists in the PDCP header, the fourth field is newly added to the PDCP header.

In some example embodiments, the sixth field uses at least one bit in the PDCP header.

In some example embodiments, packets from a higher layer are organized in unit of PDU set in the PDCP layer, and PDU set information is sent in band in PDCP header of each PDU in a PDU set.

In some example embodiments, the terminal device 120 further performs: maintaining, at the terminal device 120 during a handover execution period, common PDU set SN allocation, the PDU Set SN continuity being supported for both RLC-AM and UM DRBs configured with DAPS.

In some example embodiments, the terminal device 120 further performs; at first reception of a PDCP SDU belonging to a PDU set from upper layer, starting the discard timer associated with the PDU set; and discarding, when the discard timer expires for the SDU set, PDUs and/or SDUs belonging to the corresponding PDU set and/or PDUs and/or SDUs of other PDU sets associated with the PDU set, wherein PDUs in the same PDU set share the same discard timer.

In some example embodiments, the terminal device 120 further performs: at first reception of a PDU belonging to a PDU set from a lower layer, starting the reordering timer associated with the PDU set; and discarding, when the reordering timer expires for the SDU set, PDUs and/or SDUs belonging to the corresponding PDU set and/or PDUs and/or SDUs of other PDU sets associated with the PDU set, wherein PDUs in the same PDU set share the same reordering timer.

In some example embodiments, the terminal device 120 further performs: stopping and resetting the reordering timer if the reordering timer is running, when requested by upper layer to suspend transmission of the PDU set.

In some example embodiments, the terminal device 120 further performs: stopping and restarting the reordering timer while the reordering timer is running, when the value of the reordering timer is configured by upper layer.

In some example embodiments, the terminal device 120 further performs: discarding, when a discard timer expires for a PDCP SDU, PDUs and/or SDUs belonging to the corresponding PDU set and/or PDUs and/or SDUs of other PDU sets associated with the PDU set.

In some example embodiments, the terminal device 120 further performs: discarding, when a reordering timer expires for a PDCP SDU, PDUs and/or SDUs belonging to the corresponding PDU set and/or PDU/SDUs of other PDU sets associated with the PDU set, in response to that it is configured that all PDUs in a PDU set are needed by an application layer, and at least one PDU and/or SDU of a PDCP set is lost.

In this way, packet processing with PDU set granularity is supported, and PDU-set based handling is also supported. Therefore, processing of XR/media services can be performed in PDU set granularity instead of in PDU granularity. At the same time, the processing of each data packet in the QoS flow is no longer relatively independent; but rather, PDU set(s) which is (are) dependent on other PDU set(s) can be processed (for example, dropped/discarded) based on the other PDU set(s). As a result, communication quality and network performance are improved.

FIG. 6 illustrates a flowchart of an example method 600 implemented at a network device in accordance with some embodiments of the present disclosure. For the purpose of discussion, the method 600 will be described from the perspective of the network device 110 with reference to FIGS. 1 and 5.

At block 610, the network device 110 determines at least one of the following parameters associated with a PDU set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set. At block 620, the network device 110 transmits, to a terminal device 120, the at least one of the parameters.

In some example embodiments, at least one of the following fields is defined in the header of PDCP Data PDU: a first field indicating the SN of the PDU set to which the PDCP Data PDU belongs; a second field indicating whether the PDCP Data PDU is the first PDU of the PDU set to which it belongs; or a third field indicating whether the PDCP Data PDU is the last PDU of the PDU set to which it belongs.

In some example embodiments, at least one of the following fields is further defined in the header of PDCP Data PDU: a fourth field indicating the SN of other PDU sets, wherein the PDU set to which the PDCP Data PDU belongs is associated with PDU set specified by this field; a fifth field indicating whether the fourth field exists in the header of PDCP Data PDU; or a sixth field indicating the importance or priority of the PDU set.

In some example embodiments, the network device is a source network device 110-1 of the terminal device 120 to be handed over to a target network device 110-2.

In some example embodiments, the source network device 110-1 transmits to the target network device 110-2 a message for handover request passing information to prepare the handover to the target network device. The information comprises at least PDU set related information. The PDU set related information comprises information about at least the first parameter and the second parameter.

In some example embodiments, the source network device 110-1 further performs: maintaining, for RLC-AM bearers, PDU Set SN; and transmitting, to the target network device 110-2, the next PDU Set SN to allocate to a packet which does not have a PDU set SN.

In some example embodiments, the source network device 110-1 further performs: transmitting, to the target network device 110-2, information about at least one of the following: the first field, the second field, the third field, or size of the PDU set. In some example embodiments, the source network device 110-1 further performs:

transmitting, to the target network device 110-2, information about importance level or priority, or associated PDU set.

In some example embodiments, the source network device 110-1 further performs: sending, when DRBs are configured with DAPS, to the target network device 110-2, a message for early status transfer, the PDU Set SN and/or a value for downlink count conveyed in the message indicating PDU Set SN, PDCP SN and HEN of the first PDCP SDU that the source network device 110-1 forwards to the target network device 110-2.

In some example embodiments, the source network device 110-1 further performs: assigning SNs and/or PDU set SNs to downlink PDCP SDUs, until sending a message for SN status transfer to the target network device 110-2.

In some example embodiments, the message for SN status transfer indicates, to the target network device 110-2, the PDU set SN and count of the first missing PDCP SDU the target network device 110-2 should start delivering.

In some example embodiments, the source network device 110-1 further performs: allocating downlink PDCP SNs and/or PDU set SNs until the SN assignment is handed over to the target network device 110-2; scheduling downlink data on the source radio link and starting forwarding downlink PDCP SDUs along with assigned PDCP SNs and/or PDU set SNs to the target network device 110-2, upon allocation of downlink PDCP SNs and/or PDU set SNs by the source network device 110-1; and maintaining, after the SN assignment is handed over to the target network device 110-2, PDU set SN, HFN and PDCP SN.

In some example embodiments, the source network device 110-1 further performs: transmitting, to the target network device 110-2, information about at least one of: the first field, the second field, the third field, or size of the PDU set.

In some example embodiments, the source network device 110-1 further performs: transmitting, to the target network device 110-2, information about importance level or priority, or associated PDU set.

In some example embodiments, the source network device 110-1 further performs: transmitting, to the target network device 110-2, a message for handover request comprising PDU set related information, the PDU set related information comprising information about at least the first parameter and the second parameter; and transmitting a message for SN status transfer to the target network device.

In some example embodiments, the source network device 110-1 further performs: requesting a DAPS handover for one or more DRBs; and transmitting, for DRBs configured with DAPS, to the target network device 110-2, a message for early status transfer, the message comprising a PDU set SN and/or a value for downlink count indicating PDU set SN, PDCP SN and HFN of the first PDCP SDU that the source network device 110-1 forwards to the target network device 110-2.

In some example embodiments, the source network device 110-1 further performs: for DRBs not configured with DAPS, transmitting a message for SN status transfer to the target network device 110-2.

In some example embodiments, the network device is a target network device 110-2 for a terminal device 120 to be handed over from a source network device 110-1.

In some example embodiments, the target network device 110-2 further performs: receiving, from the source network device 110-1, a message for handover request passing information to prepare the handover at the target network device. The information comprises at least PDU set related information. The PDU set related information comprises information about at least the first parameter and the second parameter.

In some example embodiments, the target network device 110-2 further performs: upon determining that the RLC-UM bearer is configured with DAPS handover, for RLC-UM bearers, resetting PDU set SN, PDCP SN and HFN.

In this way, packet processing with PDU set granularity is supported, and PDU-set based handling is also supported. Therefore, processing of XR/media services can be performed in PDU set granularity instead of in PDU granularity. At the same time, the processing of each data packet in the QoS flow is no longer relatively independent; but rather, PDU set(s) which is (are) dependent on other PDU set(s) can be processed (for example, dropped/discarded) based on the other PDU set(s). As a result, communication quality and network performance are improved.

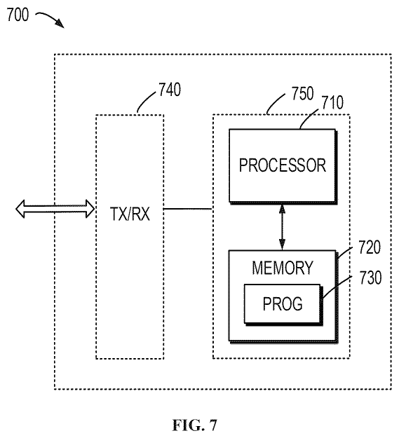

FIG. 7 illustrates a simplified block diagram of a device 700 that is suitable for implementing embodiments of the present disclosure. The device 700 can be considered as a further example implementation of the terminal device 120 and/or the network device 110 as shown in FIG. 1. Accordingly, the device 700 can be implemented at or as at least a part of the terminal device 120 or the network device 110.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 730 is assumed to include program instructions that, when executed by the associated processor 710, enable the device 700 to operate in accordance with the embodiments of the present disclosure, as discussed herein with reference to FIGS. 2-6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In summary, embodiments of the present disclosure may provide the following solutions.

The present disclosure provides a method of communication, comprises: receiving, at a terminal device from a network device, at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set, and processing the PDU set based on the received at least one of the parameters.

In one embodiment, the method as above, at least one of the following fields is defined in the header of a packet data convergence protocol (PDCP) data PDU: a first field indicating the serial number (SN) of the PDU set to which the PDCP data PDU belongs; a second field indicating whether the PDCP data PDU is the first PDU of the PDU set to which it belongs; or a third field indicating whether the PDCP data PDU is the last PDU of the PDU set to which it belongs.

In one embodiment, the method as above, at least one of the following fields is further defined in the header of a PDCP data PDU: a fourth field indicating the SN of other PDU sets, wherein the PDU set to which the PDCP data PDU belongs is associated with PDU set specified by the field; a fifth field indicating whether the fourth field exists in the header of PDCP data PDU; or a sixth field indicating the importance or priority of the PDU set.

In one embodiment, the method as above, further comprises: determining the range of count or PDCP SN that belongs to a PDU set to be from a first count or a first PDCP SN to a second count or a second PDCP SN, the first count or the first PDCP SN being a count or a PDCP SN of a PDCP Data PDU whose second field is set to 1, the second count or the second PDCP SN being a count or a PDCP SN of a PDCP Data PDU whose third field is set to 1; and determining whether a PDCP set loses at least one PDU based on the PDU set SN, the count or PDCP SN, information about the second field and the third field.

In one embodiment, the method as above, each of the second field and the third field uses one bit in the PDCP header.

In one embodiment, the method as above, the fifth field uses one bit in the PDCP header, and in response to that the fifth field indicates that the fourth field exists in the PDCP header, the fourth field is newly added to the PDCP header.

In one embodiment, the method as above, the sixth field uses at least one bit in the PDCP header.

In one embodiment, the method as above, packets from a higher layer are organized in unit of PDU set in the PDCP layer, and PDU set information is sent in band in PDCP header of each PDU in a PDU set.

In one embodiment, the method as above, further comprises: maintaining, at the terminal device during a handover execution period, common PDU set SN allocation, the PDU Set SN continuity being supported for both RLC-AM and UM DRBs configured with DAPS.

In one embodiment, the method as above, further comprises: at first reception of a PDCP SDU belonging to a PDU set from upper layer, starting the discard timer associated with the PDU set; and discarding, when the discard timer expires for the SDU set, PDUs and/or SDUs belonging to the corresponding PDU set and/or PDUs and/or SDUs of other PDU sets associated with the PDU set, wherein PDUs in the same PDU set share the same discard timer.

In one embodiment, the method as above, further comprises: at first reception of a PDU belonging to a PDU set from a lower layer, starting the reordering timer associated with the PDU set; and discarding, when the reordering timer expires for the SDU set, PDUs and/or SDUs belonging to the corresponding PDU set and/or PDUs and/or SDUs of other PDU sets associated with the PDU set, wherein PDUs in the same PDU set share the same reordering timer.

In one embodiment, the method as above, further comprises: stopping and resetting the reordering timer if the reordering timer is running, when requested by upper layer to suspend transmission of the PDU set.

In one embodiment, the method as above, further comprises: stopping and restarting the reordering timer while the reordering timer is running, when the value of the reordering timer is configured by upper layer.

In one embodiment, the method as above, further comprises: discarding, when a discard timer expires for a PDCP SDU, PDUs and/or SDUs belonging to the corresponding PDU set and/or PDUs and/or SDUs of other PDU sets associated with the PDU set.

In one embodiment, the method as above, further comprises: discarding, when a reordering timer expires for a PDCP SDU, PDUs and/or SDUs belonging to the corresponding PDU set and/or PDU/SDUs of other PDU sets associated with the PDU set, in response to that it is configured that all PDUs in a PDU set are needed by an application layer, and at least one PDU and/or SDU of a PDCP set is lost.

The present disclosure provides a method for communication, comprising: determining, at a network device, at least one of the following parameters associated with a protocol data unit (PDU) set: a first parameter indicating whether all PDUs in the PDU set are needed by an application layer; a second parameter indicating whether the PDU set is to be discarded when an additional PDU set associated with the PDU set is lost or discarded; a third parameter indicating a discard timer for the PDU set; or a fourth parameter indicating a reordering timer for the PDU set, and transmitting, to a terminal device, the at least one of the parameters.

In one embodiment, the method as above, at least one of the following fields is defined in the header of PDCP Data PDU: a first field indicating the serial number (SN) of the PDU set to which the PDCP Data PDU belongs; a second field indicating whether the PDCP Data PDU is the first PDU of the PDU set to which it belongs; or a third field indicating whether the PDCP Data PDU is the last PDU of the PDU set to which it belongs.

In one embodiment, the method as above, at least one of the following fields is further defined in the header of PDCP Data PDU: a fourth field indicating the SN of other PDU sets, wherein the PDU set to which the PDCP Data PDU belongs is associated with PDU set specified by the field; a fifth field indicating whether the fourth field exists in the header of PDCP Data PDU; or a sixth field indicating the importance or priority of the PDU set.

In one embodiment, the method as above, the network device is a source network device of the terminal device to be handed over to a target network device.

In one embodiment, the method as above, further comprises: transmitting, to the target network device, a message for handover request passing information to prepare the handover to the target network device, the information comprising at least PDU set related information, the PDU set related information comprising information about at least the first parameter and the second parameter.

In one embodiment, the method as above, further comprises: maintaining, for RLC-AM bearers, PDU set serial number (SN); and transmitting, to the target network device, the next PDU set SN to allocate to a packet which does not have a PDU set SN.

In one embodiment, the method as above, further comprises: transmitting, to the target network device, information about at least one of the following: the first field, the second field, the third field, or size of the PDU set.

In one embodiment, the method as above, further comprises: transmitting, to the target network device, information about importance level or priority, or associated PDU set.

In one embodiment, the method as above, further comprises: sending, when DRBs are configured with DAPS, to the target network device, a message for early status transfer, the PDU set SN and/or a value for downlink count conveyed in the message indicating PDU set SN, PDCP SN and HFN of the first PDCP SDU that the source network device forwards to the target network device.

In one embodiment, the method as above, further comprises: assigning SNs and/or PDU set SNs to downlink PDCP SDUs, until sending a message for SN status transfer to the target network device.

In one embodiment, the method as above, the message for SN status transfer indicates, to the target network device, the PDU set SN and count of the first missing PDCP SDU the target network device should start delivering.

In one embodiment, the method as above, further comprises: allocating downlink PDCP SNs and/or PDU set SNs until the SN assignment is handed over to the target network device; scheduling downlink data on the source radio link and starting forwarding downlink PDCP SDUs along with assigned PDCP SNs and/or PDU set SNs to the target network device, upon allocation of downlink PDCP SNs and/or PDU set SNs by the source network device; and maintaining, after the SN assignment is handed over to the target network device, PDU set SN, HFN and PDCP SN.

In one embodiment, the method as above, further comprises: transmitting, to the target network device, information about at least one of: the first field, the second field, the third field, or size of the PDU set.

In one embodiment, the method as above, further comprises: transmitting, to the target network device, information about importance level or priority, or associated PDU set.

In one embodiment, the method as above, further comprises: transmitting, to the target network device, a message for handover request comprising protocol data unit (PDU) set related information, the PDU set related information comprising information about at least the first parameter and the second parameter; and transmitting a message for SN status transfer to the target network device.

In one embodiment, the method as above, further comprises: requesting a DAPS handover for one or more DRBs; and transmitting, for DRBs configured with DAPS, to the target network device, a message for early status transfer, the message comprising a PDU set SN and/or a value for downlink count indicating PDU set SN, PDCP SN and HFN of the first PDCP SDU that the source network device forwards to the target network device.

In one embodiment, the method as above, further comprises: for DRBs not configured with DAPS, transmitting a message for SN status transfer to the target network device.

In one embodiment, the method as above, the network device is a target network device of a terminal device to be handed over from a source network device.

In one embodiment, the method as above, further comprises: receiving, from the source network device, a message for handover request passing information to prepare the handover at the target network device, the information comprising at least PDU set related information, the PDU set related information comprising information about at least the first parameter and the second parameter.

In one embodiment, the method as above, further comprises: upon determining that the RLC-UM bearer is configured with DAPS handover, for RLC-UM bearers, resetting PDU set SN, PDCP SN and HFN.

The present disclosure provides a terminal device, comprising: a processor; and a memory storing computer program codes; the memory and the computer program codes configured to, with the processor, cause the terminal device to perform the method implemented at the terminal device 120 discussed above.

The present disclosure provides a network device, comprising: a processor; and a memory storing computer program codes; the memory and the computer program codes configured to, with the processor, cause the network device to perform the method implemented at the network device 110 discussed above.

The present disclosure provides a computer readable medium having instructions stored thereon, the instructions, when executed by a processor of an apparatus, causing the apparatus to perform the method implemented at the terminal device 120 or the network device 110 discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-25. (canceled)

26. A method of a target network device, the method comprising:
receiving, from a source network device, a Handover Request message to prepare a handover, the Handover Request message comprising first information indicating whether all protocol data units (PDUs) are needed of a PDU set, and
transmitting, to a terminal device, second information indicating to perform at least one discard operation.

27. The method of the target network device according to claim 26,
wherein at least one of the all PDUs and service data units (SDUs) belonging to the PDU set are discarded by the terminal device based on a condition of a discard timer expiry.

28. The method of the target network device according to claim 26, further comprising:
receiving, from a source network device, third information, the third information comprising at least the following information:
PDU Set Sequence Number (SN);
End Indication;
Size of the PDU set; or
Importance level.

29. The method of the target network device according to claim 26,
wherein the first information is part of a Quality of Service (QOS) profile.

30. The method of the target network device according to claim 26, wherein:
at least one of the following fields is defined in the header of a packet data convergence protocol (PDCP) data PDU:
a first field indicating the serial number (SN) of the PDU set to which the PDCP data PDU belongs;
a second field indicating whether the PDCP data PDU is the first PDU of the PDU set to which it belongs; or
a third field indicating whether the PDCP data PDU is the last PDU of the PDU set to which it belongs,
wherein each of the second field and the third field uses one bit in the PDCP header.

31. The method of the target network device according to claim 30, wherein:
at least one of the following fields is further defined in the header of a PDCP data PDU:
a fourth field indicating the SN of other PDU sets, wherein the PDU set to which the PDCP data PDU belongs is associated with PDU set specified by the field;
a fifth field indicating whether the fourth field exists in the header of PDCP data PDU;
or
a sixth field indicating the importance or priority of the PDU set,
wherein in response to that the fifth field indicates that the fourth field exists in the PDCP header, the fourth field is newly added to the PDCP header, and
wherein the sixth field uses at least one bit in the PDCP header.

32. The method of the target network device according to claim 30, wherein:
the terminal device determining the range of count or PDCP SN that belongs to a PDU set to be from a first count or a first PDCP SN to a second count or a second PDCP SN,
the first count or the first PDCP SN being a count or a PDCP SN of a PDCP Data PDU whose second field is set to 1, the second count or the second PDCP SN being a count or a PDCP SN of a PDCP Data PDU whose third field is set to 1; and
whether a PDCP set loses at least one PDU based on the PDU set SN, the count or PDCP SN, the terminal device determining information about the second field and the third field.

33. A method of a terminal device, the method comprising:
receiving, from a target network device by a Radio Resource Control (RRC) message, second information indicating to perform at least one discard operation, and
wherein the target network device receives, from a source network device, a Handover Request message to prepare the handover, the Handover Request message comprising first information indicating whether all protocol data units (PDUs) of a PDU set are needed for the PDU set;
determining to perform the discard operation about one of the all PDUs and service data units (SDUs) belonging to the PDU set based on the second information.

34. The method of terminal device according to claim 33,
wherein the terminal device performs the discard operation about at least one of the all PDUs and SDUs based on a condition of a discard timer expiry.

35. The method of the terminal device according to claim 33,
wherein the target network device further receives third information, the third information comprising at least the following information:
PDU Set Sequence Number (SN);
End Indication;
Size of the PDU set; or
Importance level.

36. The method of the terminal device according to claim 33,
wherein the first information is part of a Quality of Service (QOS) profile.

37. The method of the terminal device according to claim 33, wherein:
at least one of the following fields is defined in the header of a packet data convergence protocol (PDCP) data PDU:
a first field indicating the serial number (SN) of the PDU set to which the PDCP data PDU belongs;
a second field indicating whether the PDCP data PDU is the first PDU of the PDU set to which it belongs; or
a third field indicating whether the PDCP data PDU is the last PDU of the PDU set to which it belongs,
wherein each of the second field and the third field uses one bit in the PDCP header.

38. The method of the terminal device according to claim 37, wherein:
at least one of the following fields is further defined in the header of a PDCP data PDU:
a fourth field indicating the SN of other PDU sets, wherein the PDU set to which the PDCP data PDU belongs is associated with PDU set specified by the field;
a fifth field indicating whether the fourth field exists in the header of PDCP data PDU; or
a sixth field indicating the importance or priority of the PDU set,
wherein in response to that the fifth field indicates that the fourth field exists in the PDCP header, the fourth field is newly added to the PDCP header, and
wherein the sixth field uses at least one bit in the PDCP header.

39. The method of the terminal device according to claim 37, further comprising:
determining the range of count or PDCP SN that belongs to a PDU set to be from a first count or a first PDCP SN to a second count or a second PDCP SN, the first count or the first PDCP SN being a count or a PDCP SN of a PDCP Data PDU whose second field is set to 1, the second count or the second PDCP SN being a count or a PDCP SN of a PDCP Data PDU whose third field is set to 1; and
determining whether a PDCP set loses at least one PDU based on the PDU set SN, the count or PDCP SN, information about the second field and the third field.

40. The method of the terminal device according to claim 37, further comprising:
maintaining, at the terminal device during the handover execution period, common PDU set SN allocation, the PDU Set SN continuity being supported for both radio link control-acknowledgement (RLC-AM) and unacknowledgement (UM) data radio bearers (DRBs) configured with dual active protocol stack (DAPS).

41. A target network device, comprising:
a memory configured to store instructions; and
a processor configured to execute the instructions to:
receive, from a target network device by a Radio Resource Control (RRC) message, second information indicating to perform at least one discard operation, and
wherein the target network device receives, from a source network device, a Handover Request message to prepare the handover, the Handover Request message comprising first information indicating whether all protocol data units (PDUs) of a PDU set are needed for the PDU set;
determine to perform the discard operation about one of the all PDUs and service data units (SDUs) belonging to the PDU set based on the second information.

42. The target network device according to claim 41,
wherein the terminal device performs the discard operation about one of the all PDUs and SDUs based on a condition of a discard timer expiry.

43. The target network device according to claim 41, the processor further executing the instructions to:
receive, from a source network device, third information, the third information comprising at least the following information:
PDU Set Sequence Number (SN);
End Indication;
Size of the PDU set; or
Importance level.

44. The target network device according to claim 41,
wherein the first information is part of a Quality of Service (QOS) profile.

45. The target network device according to claim 41, wherein:
at least one of the following fields is defined in the header of a packet data convergence protocol (PDCP) data PDU:
a first field indicating the serial number (SN) of the PDU set to which the PDCP data PDU belongs;
a second field indicating whether the PDCP data PDU is the first PDU of the PDU set to which it belongs; or
a third field indicating whether the PDCP data PDU is the last PDU of the PDU set to which it belongs,
wherein each of the second field and the third field uses one bit in the PDCP header.
